(19) United States
(12) Patent Application Publication
(10) Pub. No.: US 2023/0311693 A1
(43) Pub. Date: Oct. 5, 2023

(54) CHARGING MANAGEMENT METHOD OF ELECTRIC VEHICLE

(71) Applicant: MOBILETRON ELECTRONICS CO.,LTD., Taichung City (TW)

(72) Inventors: SHENG-HSIUNG LIN, Kaohsiung City (TW); Pei-Chen Liu, Taichung City (TW); Jie-Yu Lin, Taichung City (TW); Wei-Ru Chen, Taichung City (TW)

(73) Assignee: MOBILETRON ELECTRONICS CO., LTD., Taichung City (TW)

(21) Appl. No.: 18/121,923

(22) Filed: Mar. 15, 2023

(30) Foreign Application Priority Data
Mar. 29, 2022 (TW) 111111922

(51) Int. Cl. B60L 53/66; B60L 58/15; B60L 53/62; B60L 53/67; B60L 53/68

(52) U.S. Cl. CPC B60L 53/62; B60L 53/66; B60L 53/67; B60L 53/68; B60L 58/15; B60L 2240/66; B60L 2240/70

(57) ABSTRACT

A method of charging management of an electric vehicle includes: get an initial power of the electric vehicle; calculate an actual power consumption of the electric vehicle in an operation period; get a remaining power by subtracting the actual power consumption from the initial power; get a predicted power consumption of the electric vehicle in a next operation period; control a charging machine to charge the electric vehicle after the electric vehicle being connected to the charging machine until a power of the electric vehicle reaches the predicted power consumption from the remaining power, thereby avoiding wasting power due to overcharging.

### BACKGROUND OF THE INVENTION

### Technical Field

The present invention relates generally to a charging of electric vehicles, and more particularly to a method of charging management of an electric vehicle.

### Description of Related Art

Conventional vehicles use fuel engines as power sources. During operation, fuel engines exhaust a large amount of exhaust gas, causing air pollution. To be able to carry heavy loads, the engines used for operation vehicles are usually diesel engines, the volume of exhaust gas of the operation vehicles is large, which causes considerable exhaust gas discharged into the air.

Electric vehicles have been developed to replace conventional vehicles for solving the problem of exhausting gas. Taking electric buses as an example, when a conventional electric bus returns to a station at the end of the day, the driver will connect a charger (e.g. a charging station) to the conventional electric bus for charging before leaving get off work, wherein no matter a remaining power of the conventional electric bus is more or less, the charger stops charging only when the conventional electric bus is fully charged. When multiple electric buses are being charged until fully charged, the power consumption of the station will be too much, and may even exceed a contracted capacity agreed between the station operator and a power company to be charged for an additional electricity fee.

Just imagine that there is an electric bus having less mileage on the next day’s route, it only needs a small amount of electricity to run, but it consumes a lot of electricity at the station when charging on the previous day, which causes a power of the station cannot be effectively utilized.

### BRIEF SUMMARY OF THE INVENTION

In view of the above, the primary objective of the present invention is to provide a method of charging management of an electric vehicle, which could effectively use power to avoid overcharging the electric vehicle.

The present invention provides a method of charging management of an electric vehicle, including following steps:
A. get an initial power of the electric vehicle;
B. calculate an actual power consumption of the electric vehicle in an operation period, and get a remaining power by subtracting the actual power consumption from the initial power;
C. get a predicted power consumption of the electric vehicle in a next operation period;
D. control a charging machine to charge the electric vehicle after the electric vehicle is connected to the charging machine until a power of the electric vehicle reaches the predicted power consumption from the remaining power.

With the aforementioned design, the power of the electric vehicle could be charged from the remaining power to the predicted power consumption that is sufficient for the next operation period, thereby the power could be effectively used to avoid wasting power due to overcharging.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a schematic view of the charging management system according to an embodiment of the present invention;

FIG. 2 is a schematic view of the electric vehicle according to the embodiment of the present invention; and

FIG. 3 is a flowchart of the method of charging management according to the embodiment of the present invention.

### DETAILED DESCRIPTION OF THE INVENTION

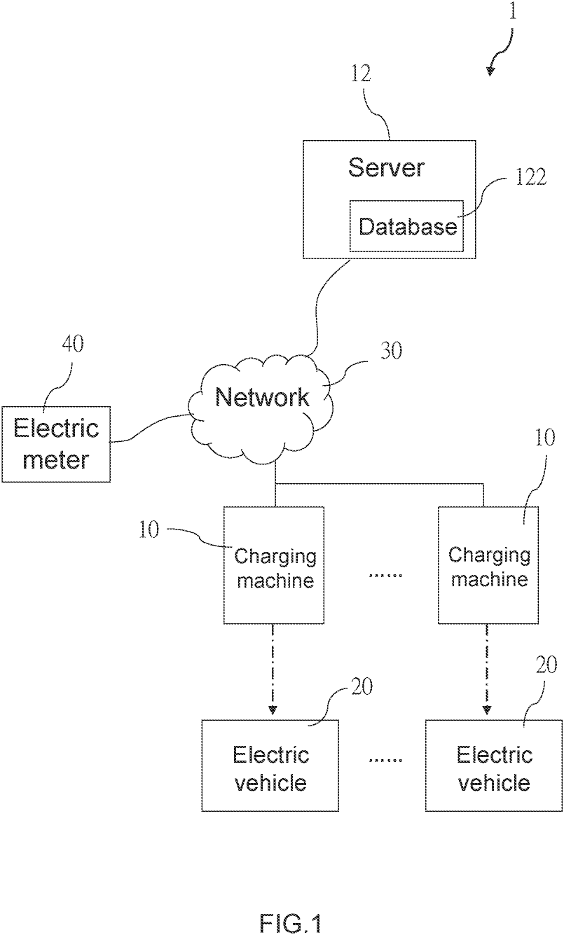

A charging management system applied to a method of charging management according to an embodiment of the present invention is illustrated in FIG. 1, wherein the charging management system 1 includes at least one charging machine 10 and a server 12. In the current embodiment, the charging management system 1 includes a plurality of charging machines 10 disposed in an electricity consuming field. The electricity consuming field could be parked for at least one electric vehicle 20, and each of the electric vehicles 20 could be charged with one of the charging machines 10. In the current embodiment, the at least one electric vehicle 20 is an operation electric bus as an example, and the electricity consuming field is a station of electric bus as an example.

The server 12 is connected to a network 30. In the current embodiment, the network 30 is an internet as an example. The server 12 is wirelessly connected to the charging machines 10. In the current embodiment, the server 12 communicates with the charging machines 10 via the internet. However, this is not a limitation of the present invention, the server 12 could communicate with the charging machines 10 via a local area network or other protocols such as CAN-bus. The server 12 has a database 122 for storing data in the database 122, wherein the data stored in the database 122 include a past information of each of the electric vehicles 20, and an operation period to be dispatched next and a route information to be dispatched next of each of the electric vehicles 20. The past information includes an identification code of each of the electric vehicles 20, an actual power consumption for each of the operation periods (such as each day) that has been completed before, a route information of each of the operation periods, a weather information of each of the operation periods, etc., wherein the weather information could be obtained by connecting the server 12 to a weather forecast website through the network 30, and the route information includes a running route and a mileage.

At least one electric meter 40 is disposed in the electricity consuming field and is connected to a power grid. The server 12, the charging machines 10, and other electricity consuming devices are connected to the power grid through the electric meter 40 to obtain an electricity from the power grid. The electric meter 40 communicates with the server 12 through the network 30, and the server 12 obtains a power consumption of the electricity consuming field through the electric meter 40 for monitoring.

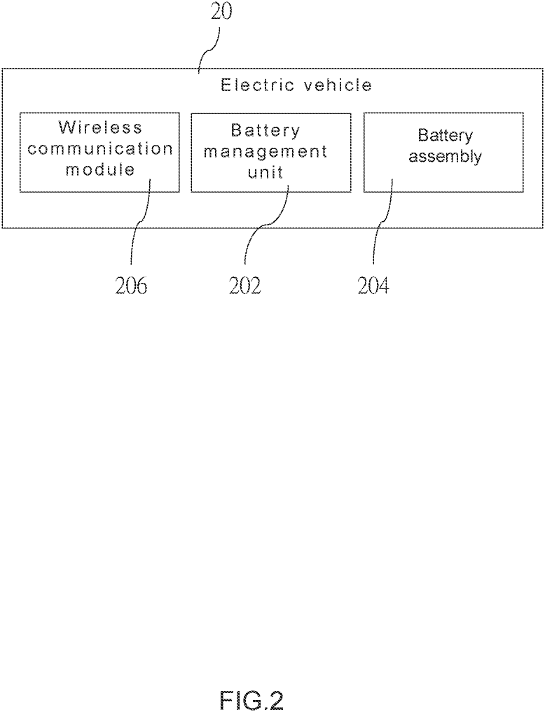

Referring to FIG. 2, each of the electric vehicles 20 includes a battery management unit 202, a battery assembly 204, and a wireless communication module 206. The battery management unit 202 is electrically connected to the battery assembly 204 for monitoring battery states of the battery assembly 204, wherein the battery states include a voltage value, a current value, a temperature, a state of charge (SOC), a state of health (SOH), etc. The battery assembly 204 could be a lithium iron phosphate battery as an example. The wireless communication module 206 is connected to the network 30 through a mobile network to communicate with the server 12. The battery management unit 202 transmits the battery states to the server 12 through the wireless communication module 206.

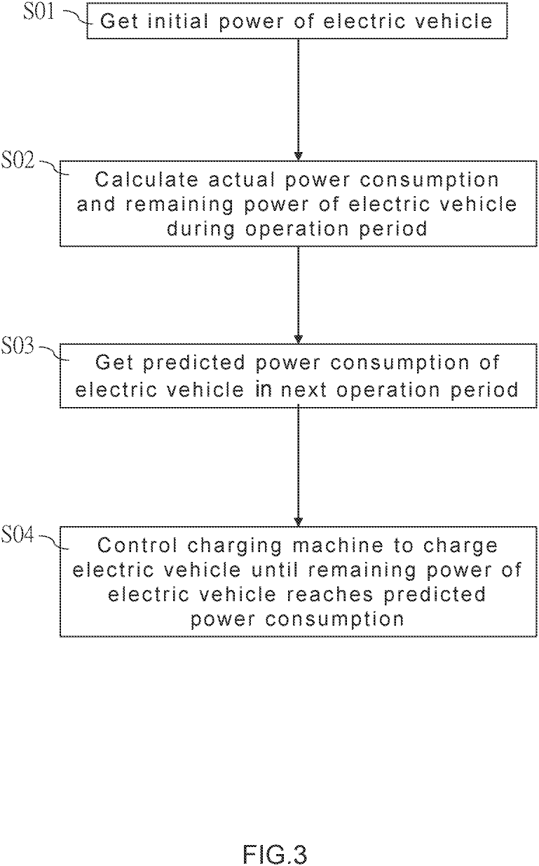

The method of charging management of the current embodiment is taken by the charging management system 1, including following steps as shown in FIG. 3. To illustrate easily, we will only describe the details of one of the electric vehicles 20 in the following paragraphs.

Step S01: get an initial power of the electric vehicle 20.

In the current embodiment, the server 12 communicates with the electric vehicle 20 and receives a current power sent from the electric vehicle 20 as the initial power before an operation period of the electric vehicle 20 starts; the operation period is a daily schedule of the electric vehicle 20 as an example (e.g. the operation period could be 8:00 to 17:00). At a preparation time before the start of the operation period, the battery management unit 202 transmits the current power to the server 12 when a driver activates the electric vehicle 20. The battery management unit 202 of the electric vehicle 20 further records an identification code of the electric vehicle 20 and an identification code of the driver and uploads the identification code of the electric vehicle 20 and the identification code of the driver to the server 12.

During the operation period, the driver drives the electric vehicle 20 according to a running route.

Step S02: calculate an actual power consumption of the electric vehicle 20 during the operation period, and subtract the actual power consumption from the initial power to obtain a remaining power.

In the current embodiment, the server 12 gets an electricity consuming information of the electric vehicle 20 during the operation period from the electric vehicle 20, and calculates the actual power consumption based on the electricity consuming information, wherein the electricity consuming information includes a plurality of fetch timestamps and the battery states respectively corresponding to the fetch timestamps. More specifically, during the operation period, the battery management unit 202 of the electric vehicle 20 continuously retrieves a battery state of the battery assembly 204 every sampling time, and sends a fetch timestamp and the corresponding battery state to the server 12 via the network 30, thereby forming the electricity consuming information, wherein the sampling time could be, for example, 10 seconds. The battery management unit 202 of the electric vehicle further transmits the identification code of the electric vehicle to the server 12, and the server 12 receives the identification code of the electric vehicle 20 through the network 30 and stores the identification code of the electric vehicle 20 in the database 122.

After the operation period, the server 12 calculates the actual power consumption based on the fetch timestamps and the current values by using a coulomb counting method. The advantage of using the coulomb counting method to calculate the actual power consumption is that it is calculated based on a current consumption of an actual electric vehicle, and the actual power consumption could be accurately calculated. After obtaining the actual power consumption, the server 12 calculates the remaining power.

In an embodiment, during the operation period, the electricity consuming information of the electric vehicle 20 could also temporarily store the electricity consuming information in a memory of the electric vehicle 20; after returning to the electricity consuming field after the operation period, the server 12 communicates with the electric vehicle 20 and receives the electricity consuming information temporarily stored from the electric vehicle 20, and then calculates the actual power consumption and the remaining power.

Step S03: get a predicted power consumption of the electric vehicle 20 in a next operation period. In the current embodiment, the next operation period could be, for example, the next day. The predicted power consumption could be predicted by a predictive model, wherein the predictive model could be generated by machine learning. In the current embodiment, the predictive model is generated by a random forest algorithm, taking a past information of the electric vehicle 20 as an input, wherein the past information includes the actual power consumption, the route information, and the weather information of each day of the operation periods that have been completed before, step S02, etc. An output of the random forest algorithm is the predicted power consumption of the electric vehicle 20. Since the past information would affect a power consumption of the electric vehicle 20, the predicted power consumption generated could be more accurate by using the past information as an input of the random forest algorithm. In practice, the past information could further include the identification code of the electric vehicle 20 and/or the identification code of the driver. Since characteristics of each of the electric vehicles 20 are different, for example, characteristics of the battery assembly 204 would affect the power consumption, and a driving habit of the driver would also affect the power consumption of the electric vehicles 20, for example, the driver often heavily steps on the electric accelerator or lightly steps on the electric accelerator, so that the identification code of the electric vehicle 20 and/or the identification code of the driver could also be used as an input of the random forest algorithm.

With the predictive model, the server 12 at least inputs the route information and the weather information of the next operation period to the predictive model to get the predicted power consumption of the next operation period. Alternatively, in a case that the predictive model is generated with the identification code of the electric vehicle 20 and/or the identification code of the driver as the input, the server 12 further inputs the identification code of the electric vehicle 20 and/or the identification code of the driver to the predictive model when generates the predictive model, thereby generating the predicted power consumption of the next operation period. The predicted power consumption is smaller than a full power of the battery assembly 204 of the electric vehicle 20 fully charged, thereby avoiding frequently charging the battery assembly 204 to the full power that may affect the service life of the battery assembly 204. For instance, when the mileage of the running route of the next operation period of the electric vehicle 20 is a regular mileage or a short trip, the predicted power consumption is smaller than the full power. Only when the mileage of the running route of the next operation period of the electric vehicle 20 is greater than a predetermined mileage of a long-distance operation, the predicted power consumption is allowed to be equal to the full power. The weather information of the next operation period could be obtained through a weather forecast website.

In addition to predicting the predicted power consumption of the next operation period with the predictive model, in an embodiment, the predictive model could include a lookup table that is pre-built, which records a predicted power consumption of each of various route information in the lookup table under different weather conditions. In this way, the corresponding predicted power consumption could be obtained by inputting the route information and the weather information of the next operation period into the predictive model and comparing it with the lookup table.

The server 12 records the identification code of the electric vehicle 20 and the corresponding predicted power consumption in the database 122, subtracts the remaining power from the predicted power consumption to obtain a required power, and records the required power in the database 122.

Step S04: after the electric vehicle 20 is connected to one of the charging machines 10, control the corresponding charging machine 10 to charge the electric vehicle 20 until a power of the electric vehicle 20 reaches the predicted power consumption from the remaining power.

In the current embodiment, after the electric vehicle 20 is connected to one of the charging machines 10, the battery management unit 202 communicates with the corresponding charging machine 10 and transmits the identification code of the electric vehicle 20 to the corresponding charging machine 10, and the charging machine 10 transmits a charging inquiry command to the server 12, wherein the charging inquiry command includes the identification code of the electric vehicle 20, and the server 12 transmits the required power corresponding to the identification code of the electric vehicle 20 to the corresponding charging machine 10 based on the charging inquiry command, and controls the corresponding charging machine 10 to charge the electric vehicle 20. In an embodiment, the server 12 could determine whether a current time falls within an off-peak power consumption period of the electricity consuming field; if the current time falls within the off-peak power consumption period of the electricity consuming field, the server 12 controls the charging machine 10 to start to charge the electric vehicle 20; otherwise, the server 12 controls the charging machine 10 to start to charge the electric vehicle 20 when the current time falls within the off-peak power consumption period of the electricity consuming field.

During a process of charging, the charging machine 10 stops charging when a power that the charging machine 10 outputs to the electric vehicle 20 reaches the required power. In this way, the power of the electric vehicle 20 could reach the predicted power consumption from the remaining power.

Additionally, the server 12 monitors an instant power consumption of the electric meter 40 (i.e., an instant power consumption of the electricity consuming field), wherein during the process of charging, when the instant power consumption is greater than a predetermined power consumption, the server 12 controls the charging machine 10 to charge the electric vehicle 20 in a way of reducing output power. For instance, the server 12 outputs a load-shedding command to the charging machine 10 to reduce a charging current that the charging machine 10 outputs to the electric vehicle 20, thereby avoiding the instant power consumption of the electricity consuming field exceeding an upper limit power consumption, wherein the upper limit power consumption is greater than the predetermined power consumption.

In an embodiment, after the electric vehicle 20 is connected to the corresponding charging machine 10, the battery management unit 202 communicates with the charging machine 10 and transmits the identification code of the electric vehicle 20 to the corresponding charging machine 10; the charging machine 10 transmits a charging inquiry command to the server 12, wherein the charging inquiry command includes the identification code of the electric vehicle 20; the server 12 transmits the predicted power consumption corresponding to the identification code of the electric vehicle 20 to the corresponding charging machine 10 based on the charging inquiry command, and controls the corresponding charging machine 10 to charge the electric vehicle 20. During a process of charging, the charging machine 10 obtains a power of the electric vehicle 20 during the process of charging from the battery management unit 202, and controls the corresponding charging machine 10 stops charging when the power obtained reaches the predicted power consumption. In this way, the power of the electric vehicle 20 could reach the predicted power consumption from the remaining power as well.

In summary, the method of charging management of the electric vehicle 20 of the present invention could get the remaining power and the predicted power consumption of the next operation period after the operation period of the electric vehicle 20 is completed, and could charge the power of the electric vehicle 20 from the remaining power to the predicted power consumption, allowing the electric vehicle 20 has enough power in the next operation period, effectively managing and using power, not wasting the power consumption of the electricity consuming field due to overcharging. When multiple electric vehicles are being charged, they would not waste too much electricity in the electricity consuming field, thereby achieving the purpose of using electricity more effectively within the contracted capacity established with the electricity company.

It must be pointed out that the embodiments described above are only some preferred embodiments of the present invention. All equivalent methods which employ the concepts disclosed in this specification and the appended claims should fall within the scope of the present invention.

What is claimed is:

1. A method of charging management of an electric vehicle, comprising steps of:
A. getting an initial power of the electric vehicle;
B. calculating an actual power consumption of the electric vehicle in an operation period, and getting a remaining power by subtracting the actual power consumption from the initial power;
C. getting a predicted power consumption of the electric vehicle in a next operation period; and
D. controlling a charging machine to charge the electric vehicle after the electric vehicle is connected to the charging machine until a power of the electric vehicle reaches the predicted power consumption from the remaining power.

2. The method as claimed in claim 1, wherein in step B, an electricity consuming information of the electric vehicle during the operation period is obtained from the electric vehicle, and the actual power consumption is calculated based on the electricity consuming information.

3. The method as claimed in claim 2, wherein in step B, the electricity consuming information comprises a plurality of fetch timestamps and a plurality of battery states, wherein each of the plurality of battery states corresponds to one of the plurality of fetch timestamps; each of the plurality of battery states comprises a current value, and the actual power consumption is calculated based on the plurality of fetch timestamps and the current values by using a coulomb counting method.

4. The method as claimed in claim 3, wherein in step B, the electricity consuming information from the electric vehicle is received through a network during the operation period.

5. The method as claimed in claim 3, wherein in step B, the electricity consuming information from the electric vehicle is received by communicating with the electric vehicle after the operation period is completed.

6. The method as claimed in claim 1, wherein in step A, a power of the electric vehicle sent from the electric vehicle is received to use as the initial power by communicating with the electric vehicle before the operation period starts.

7. The method as claimed in claim 1, wherein in step C, the predicted power consumption is obtained by at least inputting a route information and a weather information of the next operation period to a predictive model.

8. The method as claimed in claim 1, wherein in step D, a power of the electric vehicle during a process of charging is obtained through the charging machine, and the charging machine stops charging when the power of the electric vehicle obtained reaches the predicted power consumption.

9. The method as claimed in claim 1, wherein before step D, comprising a step of getting a required power by subtracting the remaining power from the predicted power consumption; in step D, the charging machine stops charging when a power that the charging machine outputs to the electric vehicle reaches the required power.

10. The method as claimed in claim 1, wherein in step D, comprising a step of monitoring an instant power consumption of an electricity consuming field where the charging machine is located, and controlling the charging machine to charge the electric vehicle in a way of reducing output power when the instant power consumption is greater than a predetermined power consumption.

11. The method as claimed in claim 1, wherein in step D, controlling the charging machine to charge the electric vehicle when determines that a current time falls within an off-peak power consumption period of an electricity consuming field where the charging machine is located.
